(19) United States
(12) Patent Application Publication
(10) Pub. No.: US 2006/0106856 A1
(43) Pub. Date: May 18, 2006

(54) Method and system for dynamic transform and load of data from a data source defined by metadata into a data store defined by metadata

(75) Inventors: Pamela Ann Bermender, Leander, TX (US); Hung Dinh, Austin, TX (US); Teng Hu, Austin, TX (US); Sharon Dolle Scheffler, Georgetown, TX (US)

Correspondence Address: Greg Goshorn, P.C., 2110 W. Slaughter lane, SUITE 115-119, AUSTIN, TX, 78748, US

(73) Assignee: INTERNATIONAL BUSINESS MACHINES CORPORATION, ARMONK, NY (US)

(21) Appl. No.: 10/981,286

(22) Filed: Nov. 4, 2004

(51) Int. Cl. G06F 17/00; G06F 7/00

(52) U.S. Cl. 707/102

(57) ABSTRACT

Provided is a method for dynamic transform and load of data from a data source defined by metadata into a data store defined by metadata. A business rule set is created (116) based on (a) a business rule template definition, (b) metadata defining at least a portion of data of a data source, and (c) metadata defining a data store. Data from the data source is transformed (118) based on the business rule set. The data is loaded (120) into the data store based on the business rule set. The transforming and loading are repeated (122) until all desired transforming and loading of data from the data source to the data store has been accomplished. The method may be carried out through execution of a computer programming product containing suitable logic. A system (100) for dynamic transform and load is also provided.

### TECHNICAL FIELD

The present invention relates generally to extract, transform, and load from a data source to a data store and, more specifically, to a method and system for dynamic transform and load of data from a data source defined by metadata into a data store defined by metadata.

### BACKGROUND OF THE INVENTION

International Business Machines Corp. (IBM) of Armonk, N.Y. has been at the forefront of new paradigms in business computing. IBM's DB2® database solutions have served, and continue to serve, as examples of excellence. In many cases, realization of the benefits of a database solution such as IBM's DB2® requires, or is at least enhanced by, the capability to move data from a non-DB2® data source to a DB2® data store.

Where the data structure of the data to be moved does not need to be altered, it can be inserted directly into the data store. In such cases, it has been common to employ a mapping tool to map data from the data source to the data store, which is often straightforward and free of significant difficulties.

However, sometimes the data source data to be moved possesses a data structure incompatible with the data store. In these cases, it is necessary to transform the data structure(s) from the data source to the data store prior to loading the transformed data into the data store. The Extract, Transform, and Load (ETL) process addresses the issue.

A major difficulty in implementing ETL solutions is the need for creating detailed transformation instructions. The difficulty is intensified by the fact that data structures within the data source and data store will often change over time, requiring the instructions to be updated to accommodate each such change. Furthermore, the transformation instructions are written in a specialized programming language which precludes direct comprehension by most non-technical business professionals.

One approach to addressing the difficulty has been to apply the efforts of one or more skilled programmers to manually create the desired transformation instructions. This approach has several drawbacks. The approach is expensive in terms of personnel resources; it requires the further application of skilled programming efforts to adapt the instructions to changes in the data store, data source, or transformation rules; and accuracy is difficult to achieve where the instructions are lengthy and detailed, as is often the case.

Another approach provides one or more tools for generating transformation instructions for transforming data from one data structure to another. However, such tools are highly specialized to transforming data from a one particular data structure to another. In addition, such tools do not readily allow customization of transformation instructions according to specific project needs. Moreover, such tools can only create transformation instructions in the hands of skilled technical personnel.

Accordingly, there is a long felt need for a method and system for dynamic transform and load of data from a data source defined by metadata into a data store defined by metadata.

### SUMMARY OF THE INVENTION

Provided is a method for dynamic transform and load of data from a data source defined by metadata into a data store defined by metadata. The method includes (a) creating a business rule set based on a business rule definition, metadata defining a data source, and metadata defining a data store, (b) transforming data from the data source based on the business rule template definition and the business rule set, (c) loading the data into the data store based on the business rule template definition and the business rule set, and (d) repeating until finished transforming and loading data from the data source to the data store. Also provided is a computer programming product for dynamic transform and load of data from a data source defined by metadata into a data store defined by metadata. The computer programming product includes a memory and logic, stored on the memory, for performing the method.

Also provided is a system for dynamic transform and load of data from a data source defined by metadata into a data store defined by metadata. The system includes a business rule template definition and an interpreter engine. The business rule template definition is based on the metadata of the data source and the metadata of the data store. The interpreter engine is configured to read business logic statements from a business rule set. The business rule set is based on the business rule template, the metadata of the data source, and the metadata of the data store. The interpreter engine is also configured to read data from the data source, interpret the business logic statements based on the business rule template definition, transform the data based on the interpreted business logic statements, and load the transformed data into the data store.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a system for dynamic transform and load of data from a data source defined by metadata into a data store defined by metadata, in accordance with an embodiment of the present invention.

FIG. 2 is a flowchart of a method for dynamic transform and load of data from a data source defined by metadata into a data store defined by metadata, in accordance with an embodiment of the present invention.

FIG. 3 is a block diagram of an alternate system for dynamic transform and load of data from a data source defined by metadata into a data store defined by metadata, in accordance with an embodiment of the present invention.

FIG. 4 is a flowchart of an alternate method for dynamic transform and load of data from a data source defined by metadata into a data store defined by metadata, in accordance with an embodiment of the present invention.

### DETAILED DESCRIPTION OF THE FIGURES

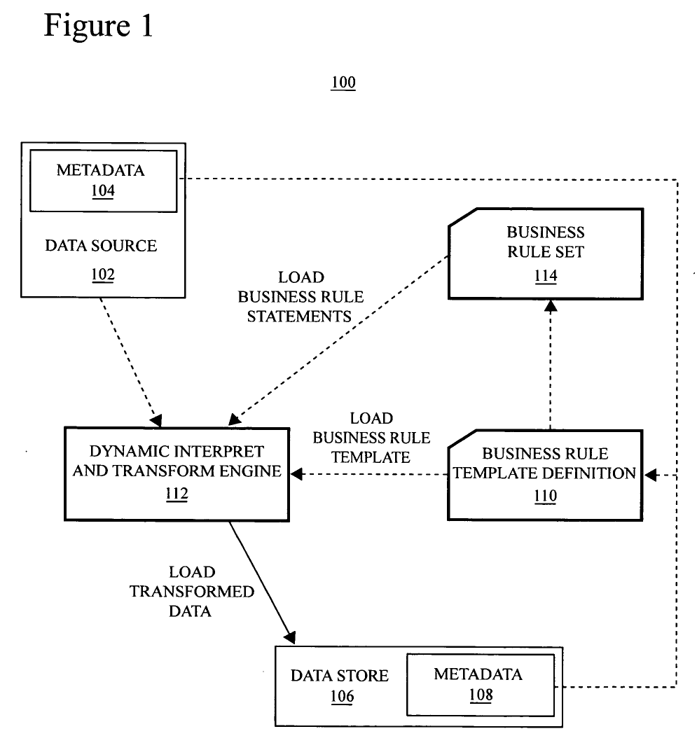

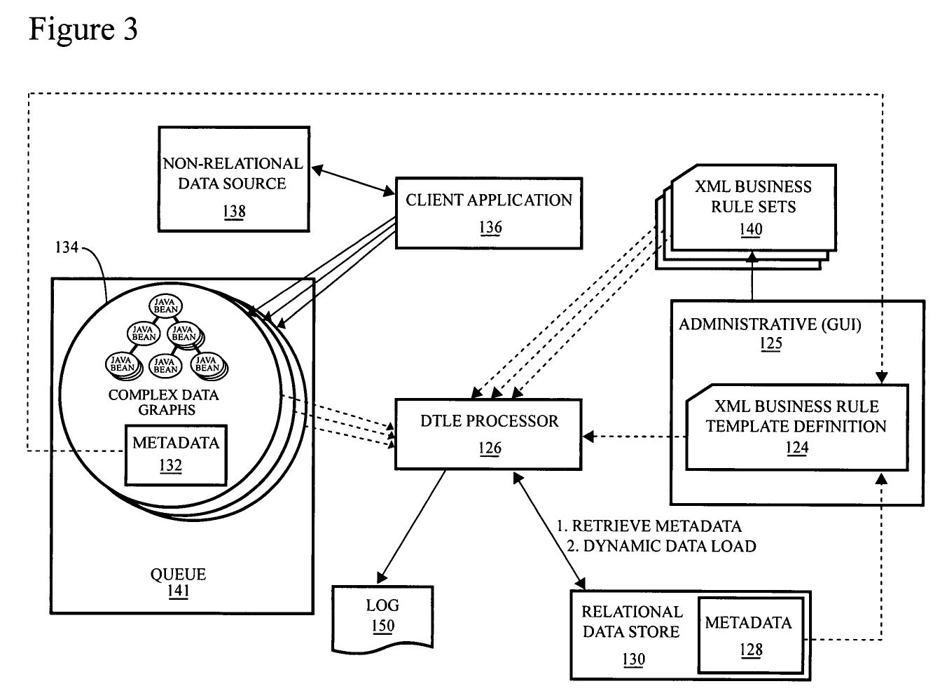

Although described with particular reference to systems as shown in FIGS. 1 and 3, the claimed subject matter can be implemented in any information technology (IT) system in which dynamic transform and load of data from a data source defined by metadata into a data store defined by metadata is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” (e.g., as used to contain the “data source,” “data store,” etc.) can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

Turning now to the figures, FIG. 1 is a block diagram of a system 100 for dynamic transform and load of data from a data source 102 defined by metadata 104 into a data store 106 defined by metadata 108, in accordance with an embodiment of the present invention. Business rule template definition 110 defines the model and semantics according to which a dynamic interpret-and-transform engine 112 operates. The business rule template definition 110 is based on metadata 108 from a data store 106 stored in a memory and metadata 104 from a data source 102 stored in a memory. Accordingly, the business rule template definition 110 is particularly customized for transforming and loading data from the data source 102 to the data store 106. A business rule set 114 is created based on the business rule template definition 110 for carrying out the dynamic transform and load.

In operation, the dynamic interpret-and-transform engine 112 loads the business rule template from the business rule template definition 110, the business rule statements from the business rule set 114, and data from the data source 102. The dynamic interpret-and-transform engine 112 transforms the data and loads the results into the data store 106 based its interpretation of the business rule statements in view of the business rule template.

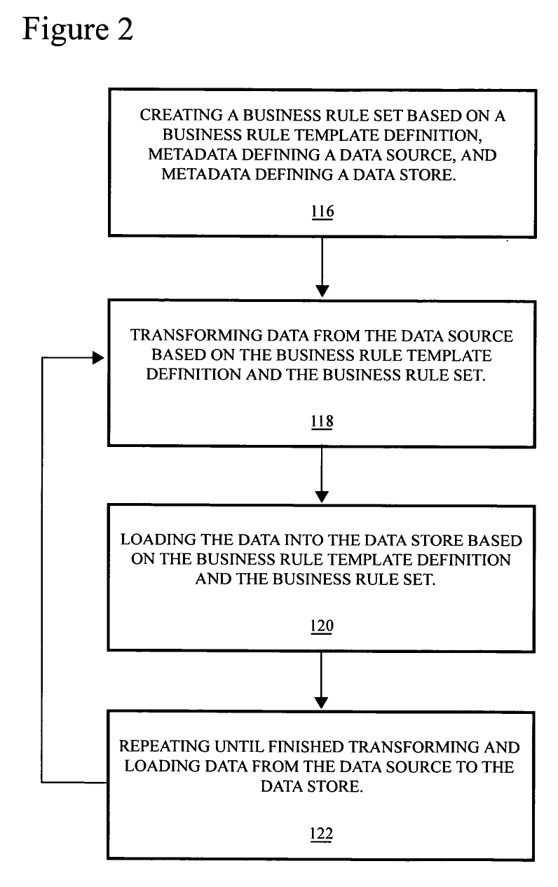

FIG. 2 depicts a flowchart of a method for dynamic transform and load of data from a data source defined by metadata into a data store defined by metadata, in accordance with an embodiment of the present invention. Block 116 includes creating a business rule set. The business rule set is based on (a) a business rule template definition, (b) metadata defining a data source, and (c) metadata defining a data store. Block 118 includes transforming data from the data source based on the business rule template definition and the business rule set. Block 120 includes loading the data into the data store based on the business rule template definition and the business rule set. The steps of Blocks 118 and 120 are repeated by virtue of Block 122 until all desired transforming and loading of data from the data source to the data store has been accomplished.

FIG. 3 shows a block diagram of an alternate system for dynamic transform and load of data from a data source defined by metadata into a data store defined by metadata, in accordance with an embodiment of the present invention. An XML business rule template definition 124 is part of an administrative graphical user interface (GUI) 125. The XML business rule template definition 124 can be read in by a dynamic transform and load engine (DTLE) processor 126 during operation of the system. The XML business rule template definition 124 is based on metadata 128 from a relational data store 130 and also metadata 132 from one or more complex data graphs 134, each comprising a hierarchy of JavaBeans. Each complex data graph 134 represents a different type of data (e.g., financial information, contractual information, agreed marketing rights, etc.). The complex data graphs 134 are created by client application 136 extracting data from a non-relational data source 138. For each complex data graph 134, an XML business rule set 140 is created through Administrative GUI 125 based on the model and semantics of XML business rule template definition 124. Subsequently, the XML business rule sets 140 are available for use in dynamically processing the complex data graphs 134. Client Application 136 pushes the complex data graphs 134 into queue 141. The DTLE processor 126 pulls the complex data graphs 134 one-by-one from the queue 141 and pulls, one-by-one, the corresponding XML business rule set 140 in order to read and interpret the business rule statements contained therein based on the XML business rule template definition 124 and metadata retrieved from the relational data store 130. The DTLE processor 126 dynamically generates SQL statements to transform the data of the current complex data graph 134 based on the interpreted statements of the current XML business rule set 140, and dynamically generates SQL statements to load the transformed data into the relational data store 130 based on the data and/or statements. The DTLE processor 126 also populates log 150 during operation.

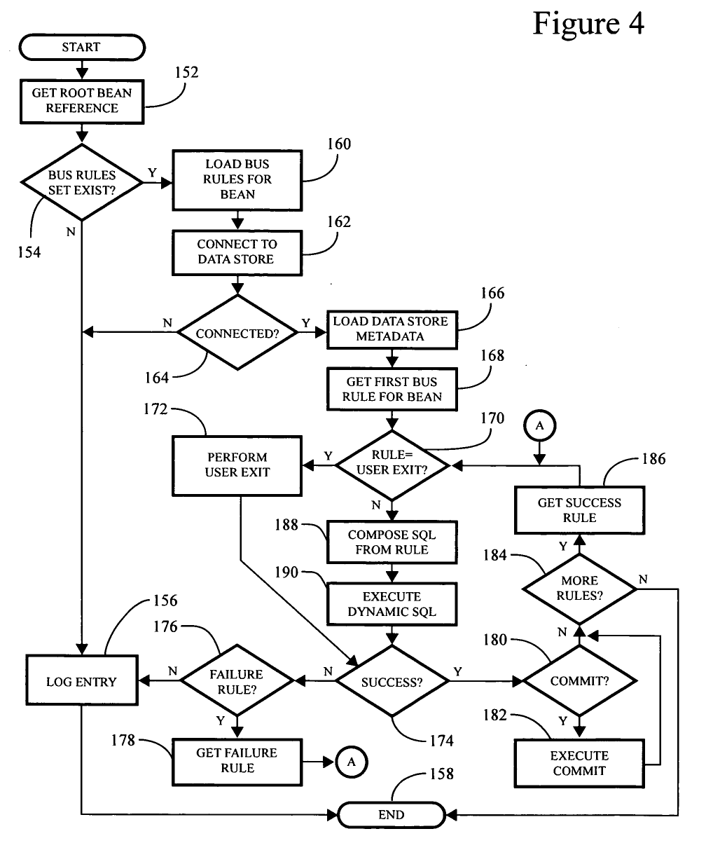

FIG. 4 presents a flowchart of an alternate method for dynamic transform and load of data from a data source defined by metadata into a data store defined by metadata, in accordance with an embodiment of the present invention. The method of FIG. 4 is one possible method by which a DTLE processor, such as the DTLE processor 126, operates. The method starts with getting 152 the root bean reference. If a business rules set does not exist 154, a log entry is made 156, and the process ends 158.

Otherwise, if a business rules set exists 154, business rules for the bean are loaded 160. A data store is connected to 162. If a connection cannot be achieved 164, a log entry is made 156, and the process ends 158. Otherwise, if a connection can be achieved 164, data store metadata is loaded 166. The first business rule for the bean is gotten 168.

If the business rule calls for a user exit 170 (e.g., for execution of specialized instructions, etc.), a user exit is performed 172. Upon return from the user exit 172, decision Block 174 is entered. If the present rule execution was unsuccessful 174, then decision Block 176 is entered. If a failure rule does not exist 176 for the current rule, a log entry is made 156, and the process ends 158. Otherwise, if a failure rule exists 176 for the current bean, the failure rule is gotten 178. The failure rule is then evaluated in Block 170 as described hereunder.

Otherwise, if the present rule execution was successful 174, then decision Block 180 is entered. If the business rule set indicates 180 that a commit should be performed, a commit is executed 182. Decision Block 184 is then entered. If no more business rules remain 184, the process ends 158. Otherwise, if more business rules remain 184, the success rule for the bean is gotten 186 and Block 170 is entered.

Otherwise, if the business rule does not call for a user exit 170, SQL is composed 188 based on the present rule. The dynamically composed SQL is then executed 190. Decision Block 174 is then entered and the success or failure status of the current SQL execution is evaluated as described hereunder for Block 174.

Table 1 contains examples of user-understandable meanings associated with tags used in the business rule template definition of Table 2 and the business rule set of Table 3.

TABLE 1

| | |
|---|---|
| 1. | mapping: XML root tag. |
| 2. | action: each action tag pertains to a specific JavaBean in the complex bean hierarchy. |
| | Properties in the action tag are as follows: |

| | |
|---|---|
| a. | classname: fully-qualified class name of the JavaBean. |
| b. | dbcommit: true/false values; true indicates to commit the database changes after |
| | executing this action. |

| | |
|---|---|
| 3. | sql: indicates the insert/update/delete/select operation. Properties in the sql tag are as |
| | follows: |

| | |
|---|---|
| a. | id: 0..N, specifies the unique sequence number for an execution step. |
| b. | schemaname: database schema name. |
| c. | tabname: database table name. |
| d. | sqltype: type of operation (values: |
| | insert/update/delete/select/currenttimestamp/identityvallocal/userexit). |
| e. | usage: if sqltype is {“select”, “currenttimestamp” or “identityvallocal”}, then |
| | usage value of “cached” indicates to cache the values extracted using this sql (for |
| | possible use by subsequent sql execution steps). |
| f. | specialclass: if sqltype is “userexit”, then the fully-qualified class name of the user |
| | exit is specified. |
| g. | specialmethod: if sqltype is “userexit”, then the value indicates the method to be |
| | executed in the user exit class. |
| h. | whereclause: string value to be included in the where clause. |
| i. | failindex: if sql execution fails, then failindex indicates which sql id to execute |
| | next. |
| j. | successindex: if sql execution is successful, then successindex indicates which sql |
| | id to execute next. |

| | |
|---|---|
| 4. | child: each child tag pertains to a specific child bean in the JavaBean. Properties in the |
| | child tag are as follows: |

| | |
|---|---|
| a. | classname: fully-qualified class name of the child JavaBean. |
| b. | attrname: specifies the attribute name in the JavaBean pertaining to the child |
| | JavaBean. |
| c. | collection: type of collection for the child JavaBean. |

| | |
|---|---|
| 5. | postsql: used for clean up after executing all the sql on the JavaBean and its children |
| | beans (has same properties as that of sql tag, except for: usage, specialclass, |
| | specialmethod). |
| 6. | col: associated with sql and postsql tags and is used to describe the database column |
| | information for sql operations. Properties in the col tag are as follows: |

| | |
|---|---|
| a. | name: database column name. |
| b. | attrname: specifies the attribute name in the JavaBean for obtaining the data for |
| | the database column. |
| c. | classname: specifies the alternative source for obtaining the data for the database |
| | column (values: cache/parent) |
| d. | method: if classname is “parent”, then the value indicates the method of the parent |
| | class to be used for obtaining the data for the database column. |
| e. | key: true/false values; true indicates this column should be included in the where |
| | clause. |
| f. | defaultvalue: specifies the default value to be used for the database column. |
| g. | lpad: specifies the string value to be appended to the data value. |

Table 2 contains an example XML business rule template definition:

TABLE 2

<?xml version=‘1.0’ encoding=“UTF-8”?>
<!ELEMENT mapping
(action+)
>
<!ELEMENT action (sql*, child*, postsql*)>
<!ATTLIST action
classname CDATA #REQUIRED
>
<!ATTLIST action
dbcommit CDATA #REQUIRED
>
<!ELEMENT child
EMPTY
>
<!ATTLIST child
attrname CDATA #REQUIRED
>
<!ATTLIST child
classname CDATA #REQUIRED
>
<!ATTLIST child
collection CDATA #IMPLIED
>
<!ELEMENT col
EMPTY
>
<!ATTLIST col
attrname CDATA #IMPLIED
>
<!ATTLIST col
classname CDATA #IMPLIED
>
<!ATTLIST col
defaultvalue CDATA #IMPLIED
>
<!ATTLIST col
key CDATA #IMPLIED
>
<!ATTLIST col
method CDATA #IMPLIED
>
<!ATTLIST col
lpad CDATA #IMPLIED
>
<!ATTLIST col
name CDATA #REQUIRED
>
<!ELEMENT postsql
(col+)
>
<!ATTLIST postsql
failindex CDATA #REQUIRED
>
<!ATTLIST postsql
id CDATA #REQUIRED
>
<!ATTLIST postsql
schemaname CDATA #IMPLIED
>
<!ATTLIST postsql
sqltype CDATA #REQUIRED
>
<!ATTLIST postsql
successindex CDATA #REQUIRED
>
<!ATTLIST postsql
tabname CDATA #REQUIRED
>
<!ATTLIST postsql
whereclause CDATA #IMPLIED
>
<!ELEMENT sql
(col*)
>
<!ATTLIST sql
specialclass CDATA #IMPLIED
>
<!ATTLIST sql
specialmethod CDATA #IMPLIED
>
<!ATTLIST sql
failindex CDATA #IMPLIED
>
<!ATTLIST sql
id CDATA #REQUIRED
>
<!ATTLIST sql
schemaname CDATA #IMPLIED
>
<!ATTLIST sql
sqltype CDATA #REQUIRED
>
<!ATTLIST sql
successindex CDATA #IMPLIED
>
<!ATTLIST sql
tabname CDATA #IMPLIED
>
<!ATTLIST sql
usage CDATA #IMPLIED
>
<!ATTLIST sql
whereclause CDATA #IMPLIED
>

Table 3 contains an example XML business rule set:

```
TABLE 3
<?xml version=“1.0” encoding=“UTF-8”?>
<mapping>
        <action classname=“com.ibm.drit.dih.beans.GtgKeywords” dbcommit=“true”>
                <sql id=“0” schemaname=“DRIW” tabname=“LKUP_DROPLIST”
                sqltype=“currenttimestamp” usage=“cached” failindex=“−1”
                successindex=“2” >
                        <col name=“RECORD_TS” />
                </sql>
                <child classname=“com.ibm.drit.dih.beans.GtgKeyEntry”
                attrname=“KeywordList” collection=“arraylist” />
                <postsql id=“0” schemaname=“DRIW” tabname=“LKUP_DROPLIST”
                whereclause=“RECORD_TS &amp;lt;? ” sqltype=“delete” failindex=“999”
                successindex=“999”>
                        <col name=“RECORD_TS” classname=“cache” key=“true”/>
                </postsql>
        </action>
        <action classname=“com.ibm.drit.dih.beans.GtgKeyEntry” dbcommit=“false”>
                <sql id=“0” sqltype=“userexit”
                specialclass=“com.ibm.drit.dtlp.client.pdi.GtgKeywordHandler”
                specialmethod = “keyNullHandler” />
                <sql id=“1” schemaname=“DRIW” tabname=“LKUP_DROPLIST”
                whereclause=“DROPLIST_CD=? ” sqltype=“update” failindex=“2”
                successindex=“999”>
                        <col name=“DROPLIST_DESC” attrname=“DescLong” />
                        <col name=“DROPLIST_SHORT” attrname=“DescShort” />
                        <col name=“CURRENT_USE” attrname=“CurrentUse”/>
                        <col name=“EXEC_NAME” attrname=“ExecName” />
                        <col name=“COMMENTS” attrname=“Comments” />
                        <col name=“ADDL_INFO” attrname=“Additionalinfo” />
                        <col name=“DROPLIST_LIST2” attrname=“Type2Desc” />
                        <col name=“ACTIVE_FLG” defaultvalue=“Y” />
                        <col name=“SEQUENCE_NBR” attrname=“SequenceNbr” />
                        <col name=“RECORD_TS” classname=“cache” />
                        <col name=“DROPLIST_CD” key=“true” attrname=“Code” />
                </sql>
                <sql id=“2” schemaname=“DRIW” tabname=“LKUP_DROPLIST”
                sqltype=“insert” failindex=“−1” successindex=“999”>
                        <col name=“DROPLIST_CD” attrname=“Code” />
                        <col name=“DROPLIST_DESC” attrname=“DescLong” />
                        <col name=“DROPLIST_SHORT” attrname=“DescShort” />
                        <col name=“CURRENT_USE” attrname=“CurrentUse”/>
                        <col name=“EXEC_NAME” attrname=“ExecName” />
                        <col name=“COMMENTS” attrname=“Comments” />
                        <col name=“ADDL_INFO” attrname=“Additionalinfo” />
                        <col name=“DROPLIST_LIST2” attrname=“Type2Desc” />
                        <col name=“ACTIVE_FLG” defaultvalue=“Y” />
                        <col name=“SEQUENCE_NBR” attrname=“SequenceNbr” />
                        <col name=“RECORD_TS” classname=“cache” />
                </sql>
                <child attrname=“TypeList”
                classname=“com.ibm.drit.dir.beans.GtgTypeEntry” collection=“arraylist”
                />
                <child attrname=“UsageList”
                classname=“com.ibm.drit.dir.beans.GtgUsageEntry” collection=“arraylist”
                />
                <postsql id=“0” schemaname=“DRIW” tabname=“MAP_LISTCONTROL”
                whereclause=“ RECORD_TS &amp;lt; ? and DROPLIST_CD = ?”
                sqltype=“delete” failindex=“−1” successindex=“1”>
                        <col name=“RECORD_TS” classname=“cache” key=“true” />
                        <col name=“DROPLIST_CD” attrname=“Code” key=“true” />
                </postsql>
                <postsql id=“1” schemaname=“DRIW” tabname=“MAP_LISTUSAGE”
                whereclause=“RECORD_TS &amp;lt;? and DROPLIST_CD = ? ”
                sqltype=“delete” failindex=“−1” successindex=“2”>
                        <col name=“RECORD_TS” classname=“cache” key=“true”/>
                        <col name=“DROPLIST_CD” attrname=“Code” key=“true” />
                </postsql>
        </action>
        <action classname=“com.ibm.drit.dih.beans.GtgTypeEntry” dbcommit=“false”>
                <sql id=“0” sqltype=“userexit”
                specialclass=“com.ibm.drit.dtlp.client.pdi.GtgKeywordHandler”
                specialmethod = “typeNullHandler” />
                <sql id=“1” schemaname=“DRIW” tabname=“MAP_LISTCONTROL”
                whereclause=“DROPLIST_CONTROL=? and DROPLIST_CD=?”
                sqltype=“update” failindex=“2” successindex=“999”>
                        <col name=“RECORD_TS” classname=“cache” />
                        <col name=“DROPLIST_CONTROL” attrname=“TypeDesc”
                        key=“true” />
                        <col name=“DROPLIST_CD” classname=“parent”
                        method=“getGtgKeyEntryParentRef( ).getCode( )” key=“true”/>
                </sql>
                <sql id=“2” schemaname=“DRIW” tabname=“MAP_LISTCONTROL”
                sqltype=“insert” failindex=“−1” successindex=“999”>
                        <col name=“DROPLIST_CD” classname=“parent”
                        method=“getGtgKeyEntryParentRef( ).getCode( )” />
                        <col name=“DROPLIST_CONTROL” attrname=“TypeDesc” />
                        <col name=“RECORD_TS” classname=“cache” />
                </sql>
        </action>
        <action classname=“com.ibm.drit.dih.beans.GtgUsageEntry” dbcommit=“false”>
                <sql id=“0” sqltype=“userexit”
                specialclass=“com.ibm.drit.dtlp.client.pdi.GtgKeywordHandler”
                specialmethod = “usageNullHandler” />
                <sql id=“1” schemaname=“DRIW” tabname=“MAP_LISTUSAGE”
                whereclause=“DROPLIST_USAGE=? and DROPLIST_CD=?”
                sqltype=“update” failindex=“2” successindex=“999”>
                        <col name=“RECORD_TS” classname=“cache” />
                        <col name=“DROPLIST_USAGE” attrname=“UsageDesc”
                        key=“true” />
                        <col name=“DROPLIST_CD” classname=“parent”
                        method=“getGtgKeyEntryParentRef( ).getCode( )” key=“true”/>
                </sql>
                <sql id=“2” schemaname=“DRIW” tabname=“MAP_LISTUSAGE”
                sqltype=“insert” failindex=“−1” successindex=“999”>
                        <col name=“DROPLIST_CD” classname=“parent”
                        method=“getGtgKeyEntryParentRef( ).getCode( )” />
                        <col name=“DROPLIST_USAGE” attrname=“UsageDesc” />
                        <col name=“RECORD_TS” classname=“cache” />
                </sql>
        </action>
</mapping>
```

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. For example, the XML business rule set 140 described in connection with FIG. 3 could be hand-coded rather than created through use of an administrative GUI 125. As another example, the XML business rule template definition 124 of FIG. 3 could be separate from the administrative GUI 125 so that its template definition is read by the administrative GUI 125 for the purpose of creating the XML business rule set 140. As yet another example, the business rule sets 140 of FIG. 3 could be replaced with a monolithic business rule set suitable for use in transforming all the complex data graphs 134.

We claim:

1. A method for dynamic transform and load of data from a data source defined by metadata into a data store defined by metadata, comprising:
creating a business rule set based on:
(a) a business rule template definition,
(b) metadata defining at least a portion of data of a data source, and
(c) metadata defining a data store;
transforming data from the data source based on the business rule set;
loading the data into the data store based on the business rule set; and
repeating the transforming and loading until all desired transforming and loading of data from the data source to the data store has been accomplished.

2. The method of claim 1, wherein the transforming step comprises:
transforming data from the data source based on the business rule template definition and the business rule set.

3. The method of claim 2, wherein the loading step comprises:
loading the data into the data store based on the business rule template definition and the business rule set.

4. The method of claim 1, wherein the creating step comprises:
creating the business rule set using an administrative graphical user interface (GUI) based on:
(a) the business rule template definition,
(b) metadata defining at least the portion of data of the data source, and
(c) metadata defining the data store.

5. The method of claim 1, further comprising:
extracting a data graph from at least the portion of data of the data source;
wherein the creating step comprises creating the business rule set based on:
(a) the business rule template definition,
(b) metadata defining at least the portion of data of the data source, and
(c) metadata defining the data store.

6. The method of claim 5,
wherein the extracting step comprises extracting at least one other data graph from at least one other portion of data of the data source; and
wherein the creating step comprises creating at least one other business rule set based on:
(a) the business rule template definition,
(b) metadata defining said at least one other portion of data of the data source, and
(c) metadata defining the data store.

7. The method of claim 1, wherein the data source is non-relational and the data store is relational.

8. A computer programming product for dynamic transform and load of data from a data source defined by metadata into a data store defined by metadata, the product comprising:
a memory;
logic, stored on the memory, for creating a business rule set based on:
(a) a business rule template definition,
(b) metadata defining at least a portion of data of a data source, and
(c) metadata defining a data store;
logic, stored on the memory, for transforming data from the data source based on the business rule set;
logic, stored on the memory, for loading the data into the data store based on the business rule set; and
logic, stored on the memory, for repeating the transforming and loading until all desired transforming and loading of data from the data source to the data store has been accomplished.

9. The product of claim 8, wherein the logic, stored on the memory, for transforming comprises:
logic, stored on the memory, for transforming data from the data source based on the business rule template definition and the business rule set.

10. The product of claim 9, wherein the logic, stored on the memory, for loading comprises:
logic, stored on the memory, for loading the data into the data store based on the business rule template definition and the business rule set.

11. The product of claim 8, wherein the logic, stored on the memory, for creating comprises:
logic, stored on the memory, for creating the business rule set using an administrative graphical user interface (GUI) based on:
(a) the business rule template definition,
(b) metadata defining at least the portion of data of the data source, and
(c) metadata defining the data store.

12. The product of claim 8, further comprising:
logic, stored on the memory, for extracting a data graph from at least the portion of data of the data source;
wherein the logic, stored on the memory, for creating comprises logic, stored on the memory, for creating the business rule set based on:
(a) the business rule template definition,
(b) metadata defining at least the portion of data of the data source, and
(c) metadata defining the data store.

13. The product of claim 12,
wherein the logic, stored on the memory, for extracting comprises logic, stored on the memory, for extracting at least one other data graph from at least one other portion of data of the data source; and
wherein the logic, stored on the memory, for creating comprises logic, stored on the memory, for creating at least one other business rule set based on:
(a) the business rule template definition,
(b) metadata defining said at least one other portion of data of the data source, and
(c) metadata defining the data store.

14. The product of claim 8, wherein the data source is non-relational and the data store is relational.

15. A system for dynamic transform and load of data from a data source defined by metadata into a data store defined by metadata, the system comprising:
a business rule template definition based on:
(a) metadata of a data source,
(b) metadata of a data store, and
(c) wherein a business rule set can be created based on the business rule template;
a processing engine operably coupled to a data source and to a data store, wherein the processing engine is configured to:
(a) read the business rule set,
(b) load data from the data source,
(c) transform the data based on the business rule set, and
(d) load the transformed data into the data store.

16. The system of claim 15, further comprising:
an administrative graphical user interface operably coupled to the processing engine and configured to create the business rule set based on the business rule template.

17. The system of claim 15, further comprising:
a plurality of business rule sets created based on the business rule template, wherein each of the plurality of business rule sets corresponds to a data type found within the data source.

18. The system of claim 17, wherein the data source comprises a plurality of complex data graphs including JavaBeans, and wherein each of the plurality of complex data graphs corresponds to a data type found within the data source.

19. The system of claim 17, further comprising:
an administrative graphical user interface operably coupled to the processing engine and configured to create the plurality of business rule sets based on the business rule template.

20. The system of claim 15, wherein the data source comprises a non-relational data source and the data store comprises a relational data store.
